(19) United States
(12) Patent Application Publication
(10) Pub. No.: US 2022/0100192 A1
(43) Pub. Date: Mar. 31, 2022

(54) SELF-GUIDED HANDLING APPARATUS COMPRISING A DETECTION MEANS

(71) Applicant: Balyo, Ivry-Sur-Seine (FR)

(72) Inventors: Guillaume Voisin, Noisy-Le-Grand (FR); Thomas Duval, Paris (FR); Fabien Bardinet, Issy-Les-Moulineaux (FR)

(21) Appl. No.: 17/420,653

(22) PCT Filed: Jan. 6, 2020
(86) PCT No.: PCT/FR2020/050008

§ 371 Date: Aug. 11, 2021

(30) Foreign Application Priority Data
Jan. 4, 2019 (FR) 1900082

(51) Int. Cl. G05D 1/02; B66F 9/06

(52) U.S. Cl. CPC G05D 1/024; G05D 2201/0216; B66F 9/063

(57) ABSTRACT

The invention relates to a self-guided handling apparatus comprising a means for detecting obstacles which comprises a telemetry means arranged at the top of a mast (2). The telemetry means comprises a first laser (4) performing a 360° horizontal scan with an opening of ±15° relative to the horizontal plane, and at least a second laser (3) having an opening of −15° to −80° and performing a scan of at least 270°, the detection means comprising a processor using the cluster of telemetric points to detect the obstacles and control the change in the displacement of the apparatus.

### FIELD OF THE INVENTION

The present invention relates to the field of automatic guided vehicles (AGV) and the operating safety of such vehicles, equipped with a number of safety sensors to provide information to a processor controlling movements and ensuring that the risks to people, machines and loads are limited.

Although automatic guided vehicles only move in spaces allocated to them, there may be situations in which someone crosses the path inadvertently. In these cases, the full certified safety system initiates immediate braking. A key element of the system is made up of individual protection sensors—equipped with a warning field and a protection field—which continuously monitor the direct surroundings of the AGV. If a person enters the warning field, the truck slows down immediately. If the person remains in front of the device, said device stops and a signal is transmitted to the control center indicating that the truck is immobilized.

All AGVs also detect objects that may be positioned to the sides of the truck along its route. The side laser scanners allow these objects to be detected in advance. Further, said scanners provide additional functionality when cornering. The sensors identify objects that could touch the outside of the truck in corners. If this is the case, said sensors stop the truck before any contact.

Additional safety is provided by a “curtain” sensor. The aim of the detection curtain is to detect objects positioned above and below the detection level of the individual protection sensor and to avoid a collision with these objects. For example, said sensor may detect pallets and loads extending too far beyond the shelving. The curtain sensor does not operate only when moving straight ahead, said sensor also “looks” forward when cornering.

### PRIOR ART

U.S. Pat. No. 8,169,596 which describes a vehicle comprising a multi-plane scanning system is known in the prior art. The vehicle has a controller that is operationally connected to a drive mechanism. The multi-plane scanning system comprises a laser range scanner coupled to the controller; a bracket configured to be secured in a fixed orientation with respect to the laser range scanner and a mirror block arranged to receive a scanning signal from the laser range scanner and to reflect the scanning signal into a plurality of directions to create multiple scanning planes. The laser range scanner is configured to receive a signal from the multiple scanning planes, communicate the signal to the controller as a detection signal, and the controller modifies the operation of the vehicle in response to the detection signal.

Patent EP0768541B1 describes a process for sensing persons and/or objects in the immediate environment of a movable automatic device by means of a sensor installed on the movable device so as to cover a determined spatial sensing field and produce a sensing signal to control the aforesaid movable automatic device, characterized in that it comprises the following steps:
the sensing signal is measured as a function of the motion of the movable device in the absence of an obstacle,
the evolution of said signal is stored in an electronic memory in order to serve as reference curve,
the value of the useful sensing signal is measured continuously and compared with the corresponding value of the aforesaid reference curve,
the deviation between the measured value of the useful signal and the corresponding value of the reference curve is used to indicate the presence of an obstacle formed by a person and/or an object in the sensing field.

Patent application EP2041515 describes a lidar-based 3-D point cloud measuring system and method that includes a base, a housing, a plurality of transmitters and detectors contained within the housing, a rotary motor that rotates the housing about the base, and a communication component that allows transmission of signals generated by the detectors to external components.

U.S. Pat. No. 5,586,620 describes another example of a forklift truck that includes a fork level sensor located in the forks, away from the vertical mast for detecting the true level of the forks, and a vision system including an assembly with one or more cameras, which may take several forms.

### Drawbacks of the Prior Art

The solutions of the prior art are not satisfactory as the positioning of the laser telemetry at a high point of the automatic guided vehicle, usually at the top of a mast, results in areas that are masked by some portions of the vehicle. This may be for example the area in front of the vehicle, masked by the wheel camber of the vehicle or the area behind or alternatively the forks of a handling device.

### Solution Provided by the Invention

To overcome this drawback, the invention relates in the most general sense to self-guided handling apparatus comprising a means for detecting [and characterizing] obstacles which comprises a telemetry means arranged at the top of a mast characterized in that said telemetry means comprises a first laser performing a 360° horizontal scan with an opening of ±15°, and at least a second laser having an opening of −15° to −80° and performing a scan of at least 270°, the detection means comprising a processor using the cluster of telemetric points to detect the obstacles and control the change in the movement of the apparatus.

### DETAILED DESCRIPTION OF A NON-LIMITING EXAMPLE OF THE INVENTION

The present invention will be better understood on reading the detailed description of a non-limiting example of the invention which follows, referring to the accompanying drawings where:

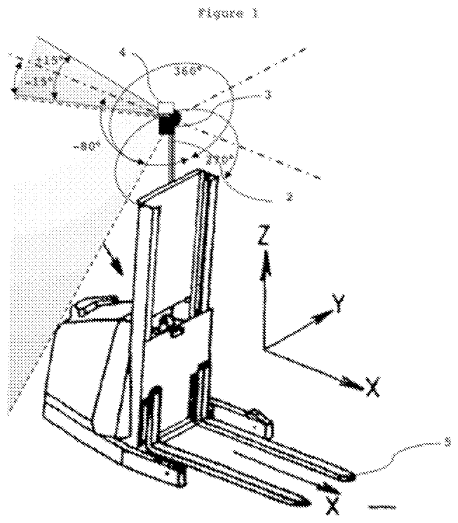

FIG. 1 is a diagrammatic view of a device according to the invention,

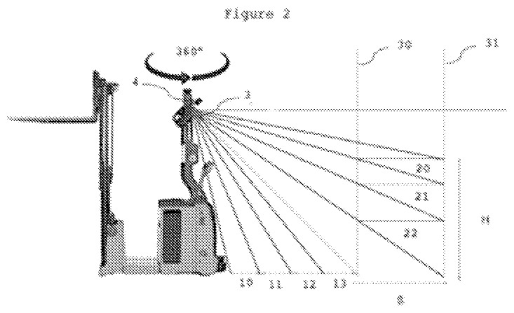

FIG. 2 is a diagrammatic view of the surfaces scanned.

FIG. 1 is a diagrammatic view of a forklift handling truck equipped with a mast (2) supporting:
a first laser (4) performing a 360° horizontal scan with an opening of ±15° relative to the horizontal plane,
at least a second laser (3) performing a scan of an additional segment of −15° to −80° relative to the horizontal plane, with a horizontal scan of 270° for the area not masked by the holding forks (5).

The second scan may also consist of a plurality of fixed imagery systems distributed in the horizontal plane about the mast (2), to cover a portion of the area that extends vertically between −15° and −80° and over 270° horizontally.

FIG. 2 shows the surfaces scanned by the lasers (3) in the horizontal plane (10 to 13), at 20-centimeter increments, and in the vertical plane (20 to 22) over a height H.

The principle is to obtain the highest possible detection height H and the smallest possible unscanned ground surface S, and thus any object crossing the area between the planes (30) and (31).

The second laser (3) is preferably a laser scanner allowing a virtual copy to be created very quickly of the setting, building or object to be digitized, at a speed of about 976,000 points per second. The point clusters collected in this way are then assembled in-house by special software using the references (spheres, checkerboard patterns, natural planes, etc.) that were pre-arranged or selected in the settings to be digitized.

The 3D model produced in this way is very precise (1 mm to 15 m). Said model also benefits from color information collected by the onboard color camera (70 megapixels with no parallax).

1. Self-guided handling apparatus comprising a means for detecting obstacles which comprises a telemetry means arranged at the top of a mast characterized in that said telemetry means comprises a first laser (4) performing a 360° horizontal scan with an opening of ±15° relative to the horizontal plane, and at least a second laser (3) having an opening of −15° to −80° and performing a scan of at least 270°, the detection means comprising a processor using the cluster of telemetric points to detect the obstacles and control the change in the movement of the apparatus.

2. Self-guided handling apparatus according to claim 1 characterized in that said second laser (3) is a laser scanner.
